(19) United States
(12) Patent Application Publication
(10) Pub. No.: US 2022/0287508 A1
(43) Pub. Date: Sep. 15, 2022

(54) VISION SYSTEM FOR A TOASTER

(71) Applicant: Haier US Appliance Solutions, Inc., Wilmington, DE (US)

(72) Inventors: Srikanth Raavi Venkata, Louisville, KY (US); Abdel Hamad, Louisville, KY (US); Gopi Varma Manthena, Hyderabad (IN); Samuel Vincent DuPlessis, Louisville, KY (US)

(21) Appl. No.: 17/197,103

(22) Filed: Mar. 10, 2021

(51) Int. Cl. A47J 37/08; A47J 36/32; G06K 9/00

(52) U.S. Cl. CPC A47J 37/085; A47J 37/0842; A47J 36/321; G06K 9/00771; G06K 2209/17

(57) ABSTRACT

A toaster includes a cabinet defining a toasting cavity for receiving a bread product and one or more heating elements positioned within the cabinet for selectively heating the toasting cavity. A camera assembly is mounted in view of the toasting cavity and a controller is configured to obtain a desired toast level, initiate a toasting cycle by energizing the one or more heating elements, obtain one or more images of the bread product within the toasting cavity using the camera assembly, analyze the one or more images using a machine learning image recognition process to determine an actual toast level of the bread product, and stop the toasting cycle when the actual toast level has reached the desired toast level.

### FIELD OF THE INVENTION

The present subject matter relates generally to toasters, and more particularly to methods of operating toasters for an improved toasting process.

### BACKGROUND OF THE INVENTION

Conventional toasters include a cabinet that defines one or more apertures for receiving bread, bagels, waffles, or other food items into a toasting cavity within the cabinet. One or more heating elements, such as electric resistance heating elements are energized to generate radiant energy that cooks or “toasts” the bread product. After the toasting process is complete, the heating elements are deenergized and a spring mechanism can eject the bread product such that it is accessible for a user to remove from the toasting cavity.

Notably, conventional toasters rely on a time-based cooking process and constant temperature heating elements. In this regard, a user may select a toaster setting, e.g., from 1 (shortest toasting time) to 10 (longest toasting time). The toaster setting may have a corresponding toast time, after which the toaster ejects the item being toasted. However, various factors other than time alone may affect how toasted a bread product becomes during the toasting cycle. For example, bread may toast differently depending on the type, freshness, moisture content, etc. More specifically, for example, older bread that is drier and has less moisture may toast much quicker than fresh bread. Improperly toasted bread can result in user dissatisfaction and frustration. In addition, over toasted bread is considered very bad for health as it contains a chemical called ‘acrylamide’ that has been classified as a neurotoxin and a carcinogen.

Accordingly, an improved toaster that improves the toasting process is desired. More specifically, a toaster and associated method of operation resulting in properly toasted bread regardless of the level of freshness or moisture content would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, a toaster is provided including a cabinet defining a toasting cavity for receiving a bread product for toasting, one or more heating elements positioned within the cabinet for selectively heating the toasting cavity, a camera assembly mounted in view of the toasting cavity, and a controller operably coupled to the camera assembly. The controller is configured to obtain a desired toast level, initiate a toasting cycle by energizing the one or more heating elements, obtain one or more images of the bread product within the toasting cavity using the camera assembly, analyze the one or more images using a machine learning image recognition process to determine an actual toast level of the bread product, and stop the toasting cycle when the actual toast level has reached the desired toast level.

In another exemplary embodiment, a method for operating a toaster is provided. The toaster includes one or more heating elements positioned within a cabinet for selectively heating a toasting cavity and a camera assembly mounted in view of the toasting cavity. The method includes obtaining a desired toast level, initiating a toasting cycle by energizing the one or more heating elements, obtaining one or more images of a bread product within the toasting cavity using the camera assembly, analyzing the one or more images using a machine learning image recognition process to determine an actual toast level of the bread product, and stopping the toasting cycle when the actual toast level has reached the desired toast level.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a toaster according to an exemplary embodiment of the present subject matter.

FIG. 2 provides another perspective view of the exemplary toaster of FIG. 1 including a camera assembly according to an exemplary embodiment of the present subject matter.

FIG. 3 provides a schematic view of the inside of the exemplary toaster of FIG. 1 according to an exemplary embodiment of the present subject matter.

FIG. 4 illustrates a method for operating a toaster according to an exemplary embodiment of the present subject matter.

FIG. 5 provides a schematic view of a bread product that has been toasted to different toast levels using the exemplary toaster of FIG. 1 as captured by the exemplary camera assembly of FIG. 2 according to example embodiments of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a 10 percent margin.

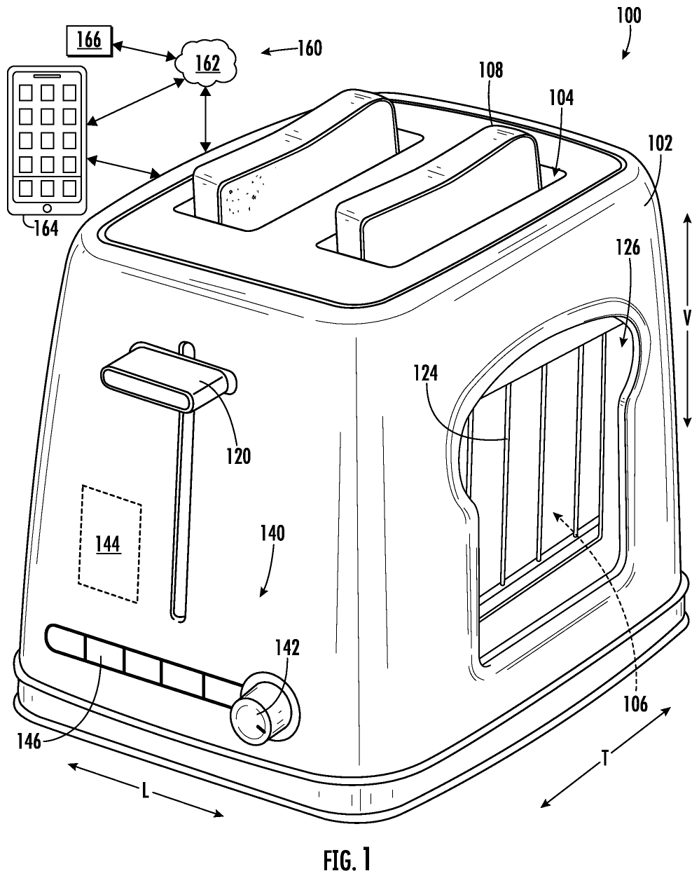

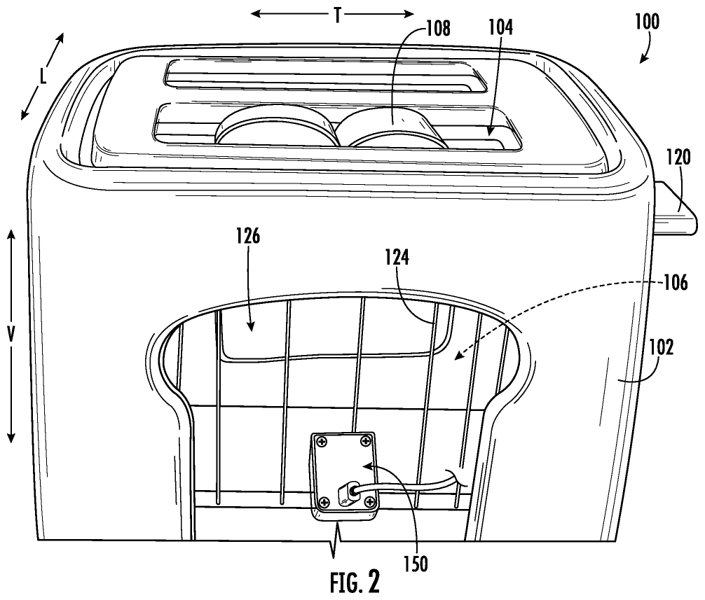

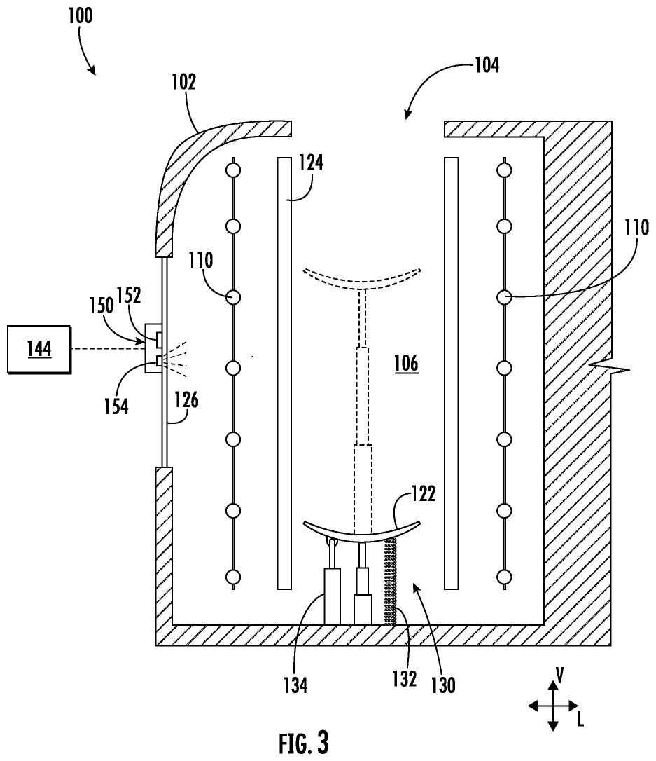

Referring now to the figures, FIGS. 1 through 3 provide various views of a toaster 100 according to an exemplary embodiment of the present subject matter. Specifically, FIGS. 1 and 2 provide perspective views of toaster 100 and FIG. 3 provides a schematic view of internal components of toaster 100 according to an exemplary embodiment of the present subject matter. Toaster 100 includes a housing or cabinet 102 that extends between a top and a bottom along a vertical direction V, between a first side and a second side along a lateral direction L, and between a front side and a rear side along a transverse direction T. Each of the vertical direction V, lateral direction L, and transverse direction T are mutually perpendicular to one another and form an orthogonal direction system.

Cabinet 102 generally contains working components of toaster 100, as will be described in more detail below. In general, cabinet 102 may be formed from any suitably rigid material for housing internal components of toaster 100. As illustrated, cabinet 102 may define one or more slots or apertures 104 in a top surface of cabinet 102. Cabinet 102 may further define one or more toasting cavities 106, each of which may correspond to and be accessible through a respective aperture 104 in cabinet 102. In this manner, as will be described in more detail below, a user may insert a bread product (e.g., as identified generally by reference numeral 108) into one or the toasting cavities 106 to facilitate a toasting process. As used herein, the term “bread product” and like is generally intended to refer to any food product suitable for toasting within toaster 100. In this regard, for example, bread product 108 may be any suitable piece, type, or size of bread, bagel, croissant, pastry, waffles, etc.

Although toaster 100 is illustrated as having two heating cavities 106, it should be appreciated that toaster 100 is provided only as an exemplary embodiment to facilitate discussion of aspects of the present subject matter. It is recognized, however, that the benefits of the present disclosure apply to other types and styles of toasters having any other suitable number of heating cavities, heating element configurations, etc. Consequently, the description set forth herein is for illustrative purposes only and is not intended to be limiting in any aspect to any particular appliance or configuration.

As described in more detail below, toaster 100 is generally configured for toasting outside of bread product 108, e.g., to slightly brown and/or crisp the outside of bread product 108. In this regard, for example, toaster 100 may include one or more heating elements 110 that are positioned within cabinet 102 to facilitate a toasting process of bread product 108. According to exemplary embodiments, heating elements 110 may be selectively energized to generate heat for toasting bread product 108. For example, heating element 110 may be a nichrome filament or rod that passes back and forth through an area adjacent heating cavity 106 for generating heat and/or infrared radiation to toast bread product 108. According to still other embodiments, heating elements 110 may be any suitable resistive heating element or other suitable wire that generates heat when energized.

Referring still to FIGS. 1 through 3, toaster 100 may include features for receiving and ejecting bread product 108 from heating cavity 106. For example, according to the illustrated embodiment, toaster 100 may include a slide handle 120 that is mechanically coupled to a support tray 122 upon which bread product 108 is seated when inserted through aperture 104. In addition, toaster 100 may include vertically extending side supports 124, e.g., to prevent bread product 108 from falling sideways and/or leaning against heating elements 110. Slide handle 120 and support tray 122 are generally slidable along the vertical direction V between a raised position (e.g., as shown in FIG. 1 and dotted lines in FIG. 3) and a lowered position (e.g., as shown in FIG. 2 and solid lines in FIG. 3). During operation, bread product 108 may be placed on support tray 122 through aperture 104 and the user may press down on slide handle 120 to lower support tray 122 and bread product 108 into heating cavity 106 to facilitate a toasting process.

According to exemplary embodiments, it may be desirable to view bread product 108 while it is being toasted within toasting cavity 106. Thus, according to the illustrated embodiment, toaster 100 may further include a window 126 that permits viewing of toasting cavity 106. In this regard, window 126 may be any suitably transparent glass, plastic, or other material that permits a user to view bread product 108 during a toasting process. It should be appreciated that the size, position, and material of window 126 may vary while remaining within the scope of the present subject matter. In addition, it should be appreciated that according to exemplary embodiments, aspects of the present subject matter may be practiced without the use of window 126, e.g., relying solely on a camera as described below.

Referring now specifically to FIG. 3, toaster 100 may further include an ejection mechanism 130 that is generally configured for discharging bread product 108 from heating cavity 106 after the toasting process has been completed. In this regard, according to the illustrated embodiment, ejection mechanism 130 generally includes a resilient element, such as a mechanical spring 132 that is configured for urging support tray 122 upward along the vertical direction V. In addition, ejection mechanism 130 may include any suitable latch mechanism 134 for securing support tray 122 in the lowered position during a toasting process. In this regard, for example, latch mechanism 134 may be a mechanical latch/release mechanism, an electromagnet latching mechanism, or any other suitable means for securing support tray 122 in the lowered position during a toasting process and selectively releasing support tray 122 after the toasting process is complete.

Toaster 100 may further include a control panel or user interface panel 140 for receiving user inputs for controlling the mode of operation or the toasting cycle of toaster 100. For example, user interface panel 140 includes one or more selector inputs 142, such as knobs, buttons, touchscreen interfaces, etc. The user may interact with user interface panel 140, e.g., via selector inputs 142, to select a level of doneness or a “toast level” of the bread product 108. In this regard, inputs 142 may be in communication with a processing device or controller 144. Signals generated in controller 144 operate toaster 100 in response to selector inputs 142. Additionally, a display 146, such as an indicator light or a screen, may be provided on control panel 140. Display 146 may be in communication with controller 144, and may display information in response to signals from controller 144.

As used herein, “processing device” or “controller” may refer to one or more microprocessors or semiconductor devices and is not restricted necessarily to a single element. The processing device can be programmed to operate toaster 100. The processing device may include, or be associated with, one or more memory elements (e.g., non-transitory storage media). In some such embodiments, the memory elements include electrically erasable, programmable read only memory (EEPROM). Generally, the memory elements can store information accessible processing device, including instructions that can be executed by processing device. Optionally, the instructions can be software or any set of instructions and/or data that when executed by the processing device, cause the processing device to perform operations.

Referring still to FIGS. 1 through 3, toaster 100 may include a camera assembly 150 that is generally positioned and configured for obtaining images of bread product 108 while being toasted within toasting cavity 106. Specifically, according to the illustrated embodiment, camera assembly 150 may include a camera 152 mounted to window 126 of toaster 100. Specifically, as illustrated, camera 152 may be mounted outside of toasting cavity 106 (e.g., on an outer surface of window 126) and may be oriented inward for viewing toasting cavity 106. Furthermore, according to exemplary embodiments, camera 152 may have a wide-angle lens, e.g., having a field-of-view greater than 120°, greater than 150°, greater than 170°, or greater. In this manner, camera 152 may view the entire bread product 108 within toasting cavity 106. In this manner, camera 152 can take unobstructed images or video of an inside of toasting cavity 106.

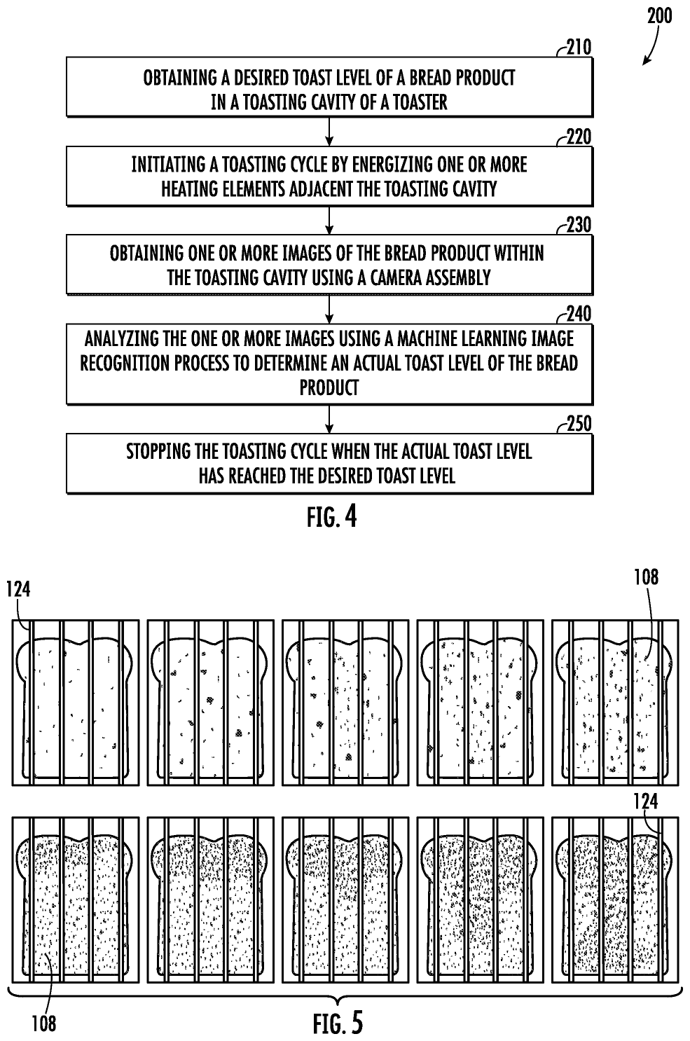

For example, exemplary images obtained by such a camera assembly 150 are provided in FIG. 4 according to exemplary embodiments. Specifically, this image shows bread product 108 as it is being toasted on a scale from 1 (top left, lightest toast level) to 10 (bottom right, darkest toast level). It should be appreciated that camera assembly 150 may include any suitable number, type, size, and configuration of camera(s) 152 for obtaining images of toasting cavity 106. It should be appreciated that other locations for mounting camera assembly 150 are possible. For example, according to another exemplary embodiment, toaster 100 may not include window 126, and camera 152 may be positioned within cabinet 102.

Referring now specifically to FIG. 3, toaster 100 may further include a light source 154 that is positioned within cabinet 102 for selectively illuminating toasting cavity 106 and the bread product 108 positioned therein. Specifically, as shown in FIG. 2, light source 154 may be integrated into camera assembly 150 and may be positioned immediately adjacent camera 152. According to still other embodiments, light source 154 may be positioned at any other suitable location within cabinet 102. It should be appreciated that according to alternative embodiments, toaster 100 may include any other camera or system of imaging devices for obtaining images of the bread products positioned therein. In addition, these cameras may be positioned at any suitable location within cabinet 102, may include any suitable lighting features, and may utilize any suitable photography or imaging technology. For example, according to still other embodiments, camera assembly 150 may include lowlight or night-vision technologies for obtaining images in low light conditions.

Notably, controller 144 of toaster 100 (or any other suitable dedicated controller) may be communicatively coupled to camera assembly 150, light source 154, and other components of toaster 100. As explained in more detail below, controller 144 may be programmed or configured for analyzing the images obtained by camera assembly 150, e.g., in order to determine the level of doneness or the actual toast level of bread products 108 positioned within toasting cavity 106, and may use this information to make informed decisions regarding the operation of toaster 100.

For example, according to exemplary embodiments, heating elements 110 and ejection mechanism 130 may be in operative communication with controller 144 to facilitate a toasting process. In this regard, for example, controller 144 may be configured for detecting when slide handle 120 is pushed toward the lowered position. Controller 144 may further be configured for engaging latch mechanism 134 and energizing heating elements 110 to initiate a toasting process. The time and intensity of the toasting process may vary based on user input via a user interface panel 140. During the toasting process, controller 144 may operate camera assembly 150 to obtain one or more images or videos of bread product 108 within toasting cavity 106. Upon completion of the toasting process, controller 144 may be configured for deenergizing heating elements 110 and ejecting bread product 108 by releasing latch mechanism 134 such that mechanical spring 132 urges support tray 122 toward the raised position.

Referring still to FIG. 1, a schematic diagram of an external communication system 160 will be described according to an exemplary embodiment of the present subject matter. In general, external communication system 160 is configured for permitting interaction, data transfer, and other communications with toaster 100. For example, this communication may be used to provide and receive operating parameters, cycle settings, performance characteristics, user preferences, or any other suitable information for improved performance of toaster 100. For example, the user may select the desired toast level (e.g., between 1 and 10), may specify the type of bread product 108 being toasted, and/or may receive a live stream or photos of bread product 108 during the toasting process.

External communication system 160 permits controller 144 of toaster 100 to communicate with external devices either directly or through a network 162. For example, a consumer may use a consumer device 164 to communicate directly with toaster 100. For example, consumer devices 164 may be in direct or indirect communication with toaster 100, e.g., directly through a local area network (LAN), Wi-Fi, Bluetooth, Zigbee, etc. or indirectly through network 162. In general, consumer device 164 may be any suitable device for providing and/or receiving communications or commands from a user. In this regard, consumer device 164 may include, for example, a personal phone, a tablet, a laptop computer, or another mobile device.

In addition, a remote server 166 may be in communication with toaster 100 and/or consumer device 164 through network 162. In this regard, for example, remote server 166 may be a cloud-based server 166, and is thus located at a distant location, such as in a separate state, country, etc. In general, communication between the remote server 166 and the client devices may be carried via a network interface using any type of wireless connection, using a variety of communication protocols (e.g. TCP/IP, HTTP, SMTP, FTP), encodings or formats (e.g. HTML, XML), and/or protection schemes (e.g. VPN, secure HTTP, SSL).

In general, network 162 can be any type of communication network. For example, network 162 can include one or more of a wireless network, a wired network, a personal area network, a local area network, a wide area network, the internet, a cellular network, etc. According to an exemplary embodiment, consumer device 164 may communicate with a remote server 166 over network 162, such as the internet, to provide user inputs, transfer operating parameters or performance characteristics, toasting parameters, etc. In addition, consumer device 164 and remote server 166 may communicate with toaster 100 to communicate similar information.

External communication system 160 is described herein according to an exemplary embodiment of the present subject matter. However, it should be appreciated that the exemplary functions and configurations of external communication system 160 provided herein are used only as examples to facilitate description of aspects of the present subject matter. System configurations may vary, other communication devices may be used to communicate directly or indirectly with one or more toaster appliances, other communication protocols and steps may be implemented, etc. These variations and modifications are contemplated as within the scope of the present subject matter.

Now that the construction of toaster 100 and the configuration of controller 144 according to exemplary embodiments have been presented, an exemplary method 200 of operating a toaster will be described. Although the discussion below refers to the exemplary method 200 of operating toaster 100, one skilled in the art will appreciate that the exemplary method 200 is applicable to the operation of a variety of other toasting appliances. In exemplary embodiments, the various method steps as disclosed herein may be performed by controller 144 or a separate, dedicated controller.

Referring now to FIG. 4, method 200 includes, at step 210, obtaining a desired toast level of the bread product in a toasting cavity of a toaster. In this regard, continuing the example from above, a user may input necessary toasting information for properly toasting a bread product 108, e.g., through user interface panel 140, a remote device 164, or in any other suitable manner. This necessary toasting information may include, for example, a bread type, the desired toast level (e.g., as measured from 1 to 10), or any other suitable data to facilitate an improved toasting process.

Step 220 includes initiating a toasting cycle by energizing one or more heating elements adjacent the toasting cavity. In this regard, for example, controller 144 may initiate heating elements 110 after slide handle 120 has been lowered and bread product 108 is positioned within toasting cavity 106. According to exemplary embodiments, the intensity of the toasting process may be manipulated by the controller 144, e.g., by varying the electrical energy supplied through heating elements 110.

Step 230 includes obtaining one or more images of the bread product within the toasting cavity using a camera assembly. In this regard, continuing the example from above, camera assembly 150 may take one or more images of toasting cavity 106, including any bread products 108 located therein. According to exemplary embodiments, step 230 may include taking one or more still images, one or more video clips, a live stream, or any other suitable type and number of images suitable for analysis of the toasting process. It should be appreciated that the images obtained by camera assembly 150 may vary in number, frequency, angle, resolution, detail, etc. in order to improve the clarity of the toasting cavity 106 and/or bread product 108. In addition, according to exemplary embodiments, controller 144 may be configured for illuminating the toasting cavity 106 using light source 154 just prior to obtaining images. According to still other embodiments, light source 154 may remain off if camera assembly 150 can obtain suitable images without extra light. For example, if the ambient lighting in a room is sufficient to illuminate toasting cavity 106 such that camera assembly 150 may obtain a suitable image facilitating the analysis described herein, light source 154 may remain off altogether.

As explained in more detail below, the one or more images or live stream of toasting cavity 106 may be used to facilitate improved toasting process. In addition, according to exemplary embodiments of the present subject matter, controller 144 may transmit the one or more images or a live stream from within toasting cavity 106 to remote device 164 (e.g., such as the user's cell phone). This live stream may be transmitted directly or indirectly through external communication system 160. The user may then interact or adjusted toasting process, e.g., via user interface panel 140 or through an application on the remote device 164.

Step 240 includes analyzing the one or more images using a machine learning image recognition process to determine an actual toast level of the bread product. As used herein, the term “actual toast level” and the like are generally intended to refer to the stage of the toasting process, the brownness of bread product 108, etc., on a scale from 1 to 10 with 1 being little or no browning and 10 being a dark or burnt toast level. Indeed, the toast level may generally refer to any qualitative or quantitative aspect of bread product 108 throughout the toasting process which may be used to facilitate an improved toasting process and finished bread product 108. It should be appreciated that controller 144 may continually monitor bread product 108 throughout the toasting process to continually track the level of doneness or the actual toast level.

As used herein, the terms image recognition process, toast level detection, and similar terms may be used generally to refer to any suitable method of observation, analysis, image decomposition, feature extraction, image classification, etc. of one or more image or videos taken within a toasting cavity of a toaster. In this regard, the image recognition process may use any suitable artificial intelligence (AI) technique, for example, any suitable machine learning technique, or for example, any suitable deep learning technique. It should be appreciated that any suitable image recognition software or process may be used to analyze images taken by camera assembly 150 and controller 144 may be programmed to perform such processes and take corrective action.

According to an exemplary embodiment, controller 144 may implement a form of image recognition called region based convolutional neural network (“R-CNN”) image recognition. Generally speaking, R-CNN may include taking an input image and extracting region proposals that include a potential object, such as a particular region of bread product 108. In this regard, a “region proposal” may be regions in an image that could belong to a particular object or region having a particular toast level. A convolutional neural network is then used to compute features from the regions proposals and the extracted features will then be used to determine a classification for each particular region.

According to still other embodiments, an image segmentation process may be used along with the R-CNN image recognition. In general, image segmentation creates a pixel-based mask for each object in an image and provides a more detailed or granular understanding of the various objects within a given image. In this regard, instead of processing an entire image—i.e., a large collection of pixels, many of which might not contain useful information—image segmentation may involve dividing an image into segments (e.g., into groups of pixels containing similar attributes) that may be analyzed independently or in parallel to obtain a more detailed representation of the object or objects in an image. This may be referred to herein as “mask R-CNN” and the like.

According to still other embodiments, the image recognition process may use any other suitable neural network process. For example, step 240 may include using Mask R-CNN instead of a regular R-CNN architecture. In this regard, Mask R-CNN is based on Fast R-CNN which is slightly different than R-CNN. For example, R-CNN first applies CNN and then allocates it to zone recommendations on the covn5 property map instead of the initially split into zone recommendations. In addition, according to exemplary embodiments standard CNN may be used to obtain a quantification of the toast level. In addition, a K-means algorithm may be used. Other image recognition processes are possible and within the scope of the present subject matter.

It should be appreciated that any other suitable image recognition process may be used while remaining within the scope of the present subject matter. For example, step 240 of analyzing the one or more images may include using a deep belief network (“DBN”) image recognition process. A DBN image recognition process may generally include stacking many individual unsupervised networks that use each network's hidden layer as the input for the next layer. According to still other embodiments, step 240 may include the implementation of a deep neural network (“DNN”) image recognition process, which generally includes the use of a neural network (computing systems inspired by the biological neural networks) with multiple layers between input and output. Other suitable image recognition processes, neural network processes, artificial intelligence (“AI”) analysis techniques, and combinations of the above described or other known methods may be used while remaining within the scope of the present subject matter.

According to exemplary embodiments of the present subject matter, the image analysis performed at step 240 may generally monitor any suitable qualitative or quantitative aspect of the bread product 108 during a toasting process. For example, the analysis may include the monitoring of at least one of a color tone or a texture of bread product 108. In addition, it should be appreciated that controller 144 may be configured for transmitting the one or more images obtained at step 230 to an artificial intelligence model, e.g., to train the model as to toast at various toast levels or to obtain the actual toast level from the artificial intelligence model. In order to train the artificial intelligence model, a database of images may be presented to the model of various types of bread products having various levels of freshness and being toasted the various toast levels under various lighting conditions. Other methods of training the artificial intelligence model or image recognition process may be used while remaining within the scope of the present subject matter.

Step 250 includes stopping the toasting cycle when the actual toast level has reached the desired toast level. In this regard, for example, controller 144 may use the image recognition process to continually monitor the level of doneness (e.g., as shown in FIG. 5). If a user selects a desired toast level of six (e.g., the bottom left square of FIG. 5), camera assembly 150 may continuously monitor bread product 108 and may use the image recognition process to determine when the bread product 108 has reached an actual toast level equal to the desired toast level. At this point, controller 144 may deenergize heating elements 110, may disengage latch mechanism 134, and/or may send a user notification that the toasting process is complete (e.g., via remote device 164).

FIG. 4 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of method 200 are explained using toaster 100 as an example, it should be appreciated that these methods may be applied to the operation of any suitable toasting appliance.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A toaster comprising:
a cabinet defining a toasting cavity for receiving a bread product for toasting;
one or more heating elements positioned within the cabinet for selectively heating the toasting cavity;
a camera assembly mounted in view of the toasting cavity; and
a controller operably coupled to the camera assembly, the controller being configured to:
obtain a desired toast level;
initiate a toasting cycle by energizing the one or more heating elements;
obtain one or more images of the bread product within the toasting cavity using the camera assembly;
analyze the one or more images using a machine learning image recognition process to determine an actual toast level of the bread product; and
stop the toasting cycle when the actual toast level has reached the desired toast level.

2. The toaster of claim 1, wherein stopping the toasting cycle comprises deenergizing the one or more heating elements.

3. The toaster of claim 1, further comprising:
an ejection mechanism for selectively ejecting the bread product, wherein stopping the toasting cycle comprises triggering the ejection mechanism to at least partially eject the bread product from the toasting cavity.

4. The toaster of claim 1, wherein the camera assembly comprises one or more cameras mounted inside the cabinet.

5. The toaster of claim 1, further comprising:
a window providing visibility into the toasting cavity, and wherein the camera assembly is mounted to the window.

6. The toaster of claim 1, further comprising:
a user interface for receiving user input regarding the toasting cycle.

7. The toaster of claim 6, wherein the user input comprises at least one of a bread type or the desired toast level.

8. The toaster of claim 1, wherein the controller is in operative communication with a remote device through an external network, and wherein the controller is configured to transmit the one or more images to the remote device.

9. The toaster of claim 1, wherein the one or more images comprises a live stream from within the toasting cavity.

10. The toaster of claim 1, wherein the machine learning image recognition process comprises at least one of a convolution neural network (“CNN”), a region-based convolution neural network (“R-CNN”), a deep belief network (“DBN”), or a deep neural network (“DNN”) image recognition process.

11. The toaster of claim 1, wherein analyzing the one or more images using a machine learning image recognition process comprises using an artificial intelligence model trained with a database of images of bread products having various levels of freshness, various bread types, and being toasted to various toast levels under varying lighting conditions.

12. The toaster of claim 10, wherein the controller is configured to:
transmit the one or more images for training the artificial intelligence model.

13. The toaster of claim 1, wherein the camera assembly comprises a wide-angle camera for viewing the entire bread product in each of the one or more images.

14. The toaster of claim 1, wherein the camera assembly comprises low light or night vision technologies for obtaining images in low light conditions.

15. The toaster of claim 1, wherein the camera assembly includes a light source for illuminating the toasting cavity while obtaining the one or more images.

16. A method for operating a toaster, the toaster comprising one or more heating elements positioned within a cabinet for selectively heating a toasting cavity and a camera assembly mounted in view of the toasting cavity, the method comprising:
obtaining a desired toast level;
initiating a toasting cycle by energizing the one or more heating elements;
obtaining one or more images of a bread product within the toasting cavity using the camera assembly;
analyzing the one or more images using a machine learning image recognition process to determine an actual toast level of the bread product; and
stopping the toasting cycle when the actual toast level has reached the desired toast level.

17. The method of claim 16, wherein the toaster further comprises an ejection mechanism for selectively ejecting the bread product, and wherein stopping the toasting cycle comprises deenergizing the one or more heating elements and ejecting the bread product.

18. The method of claim 16, wherein the machine learning image recognition process comprises at least one of a convolution neural network (“CNN”), a region-based convolution neural network (“R-CNN”), a deep belief network (“DBN”), or a deep neural network (“DNN”) image recognition process.

19. The method of claim 16, wherein analyzing the one or more images using a machine learning image recognition process comprises using an artificial intelligence model trained with a database of images of bread products having various levels of freshness, various bread types, and being toasted to various toast levels under varying lighting conditions.

20. The method of claim 19, wherein the controller is configured to:
transmit the one or more images for training the artificial intelligence model.
